(19) United States
(12) Patent Application Publication
(10) Pub. No.: US 2008/0047799 A1
(43) Pub. Date: Feb. 28, 2008

(54) Functional Motor Vehicle Assembly Comprising a Wet Clutch Transmission Element and a Hydraulic System, and Motor Vehicle Equipped with Same

(75) Inventors: Emmanuel Combes, Saint-Cyr-sous-Dourdan (FR); Christophe Dubarry, Nozay (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/570,021

(22) PCT Filed: May 26, 2005
(86) PCT No.: PCT/FR05/50378

§ 371 Date: Feb. 6, 2007

(30) Foreign Application Priority Data
Jun. 3, 2004 (FR) 0406025

(51) Int. Cl. F16D 35/00; F16D 13/00

(52) U.S. Cl. 192/58.5; 192/113.1; 903/912

(57) ABSTRACT

The invention concerns an assembly comprising a hydraulic system (401, 501) and a transmission element including an input shaft, an output shaft, an electrical machine including a rotor, a first clutch between the input shaft and the rotor, and a second clutch between the rotor and the output shaft, said clutches being of the wet type, said transmission element further comprising a lubricating circuit (301), and means for controlling said clutches, which include a control circuit (302) comprising a pressure chamber (201, 202) for each clutch. One of said circuits (301, 303) is connected to said hydraulic system (401, 501). The invention also concerns a motor vehicle equipped with such a functional assembly.

The present invention concerns a functional motor vehicle assembly comprising:
at least one hydraulic system equipped with a tank of fluid, a receptor member, and a pump connected, on the one hand, to said tank, and on the other hand, to said receptor member, adapted to supply the receptor member with fluid from the tank, and
a transmission element comprising a movement input shaft intended to be connected to a thermal engine, a movement output shaft intended to be connected to a gear box, an electrical machine comprising a stator and a rotor, a first intermediate member between the input shaft and the rotor, and a second intermediate member between the rotor and the output shaft, said clutches being of the wet type, said transmission element further comprising a circuit of lubrication and/or cooling fluid, and control means of said clutches, which comprise a circuit of control fluid, the control circuit comprising a pressure chamber for each clutch, such that the control fluid pressure prevailing in a pressure chamber determines the state of the respective clutch.

A transmission element of the type described above is used in the traction chain of some hybrid vehicles. More precisely, such an element can be used in a parallel hybrid traction chain.

By parallel hybrid traction chain, it is meant a traction chain providing to a wheel shaft a mechanical energy from at least one engine of the “irreversible” type (in general, a thermal engine) and at least one engine of the “reversible” type (in general, an electrical machine, which will be designated also by the term “the electric motor,” it being understood that this “motor” can operate according to a motor mode and a generator mode), and in which the energy node coming from these two engines has a mechanical nature.

French patent application FR 2 814 121 describes a transmission element of this type, whose control and lubrication and/or cooling circuits are independent from any other hydraulic system of the vehicle.

As a consequence, the architecture of hydraulic circuits is complex, due to a high number of parts such as tanks and pumps. As a result, the general size of the hydraulic circuits of the vehicle, in particular, in the vicinity of the engine-transmission unit, is penalizing.

An objective of the invention is to remedy these drawbacks, and to propose a functional assembly of the type described above, whose hydraulic circuits are simplified and implement a reduced number of parts.

To this effect, in a functional assembly conform to the invention, one of said circuits is connected to said hydraulic system, so that the fluid of said circuit is identical to the fluid of said hydraulic circuit, and said circuit is supplied with fluid from said tank by said pump.

According to other characteristics of the invention, taken alone or according to all combinations that can be envisioned technically:
said hydraulic system is a lubrication and/or cooling system of a second transmission element which constitutes the receptor member, or a hydraulic power steering system in which the receptor member is a power steering actuator, or a hydraulic braking system in which the receptor member is a brake, or a hydraulic suspension system in which the receptor member is a hydraulic cylinder, and the circuit connected to said hydraulic system is the circuit of lubrication and/or cooling fluid;
said hydraulic system is a gear box system, in particular a driven manual gear box, the receptor member comprising a selection actuator and a gear shifting actuator, and the circuit connected to said hydraulic system is the circuit of control fluid;
the transmission element comprises two such hydraulic systems, connected to the circuit of lubrication and/or cooling fluid and to the circuit of control fluid, respectively;
said control means comprise return means of the two clutches into closed position;
the control circuit is essentially distinct from the lubrication and/or cooling circuit; and
the control fluid is of a different nature from the lubrication and/or cooling fluid.

Another object of the invention is a motor vehicle comprising a functional assembly as described above.

A particular embodiment of the invention will now be described in more details in reference to the annexed drawings, in which:

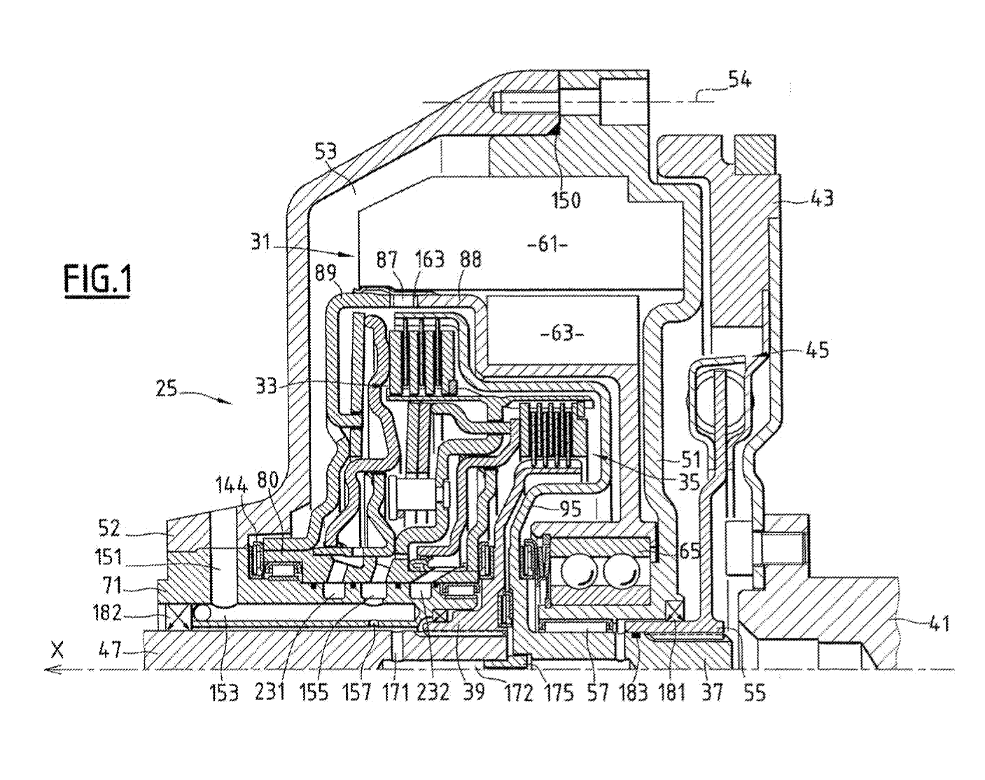

FIG. 1 is a partial view in axial partial cross-section of the transmission element of a functional assembly according to the invention;

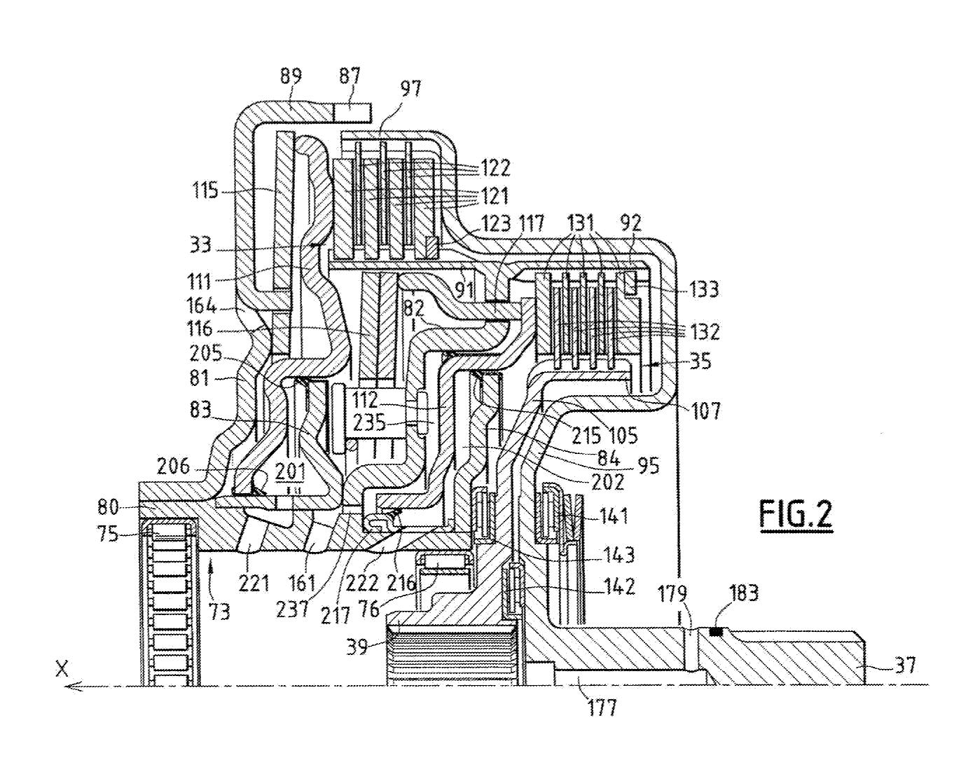

FIG. 2 is a view of a detail of FIG. 1, at a larger scale, which shows a module of the transmission element, comprising essentially the clutches, the input and output shafts, the intermediate member, and the pistons; and

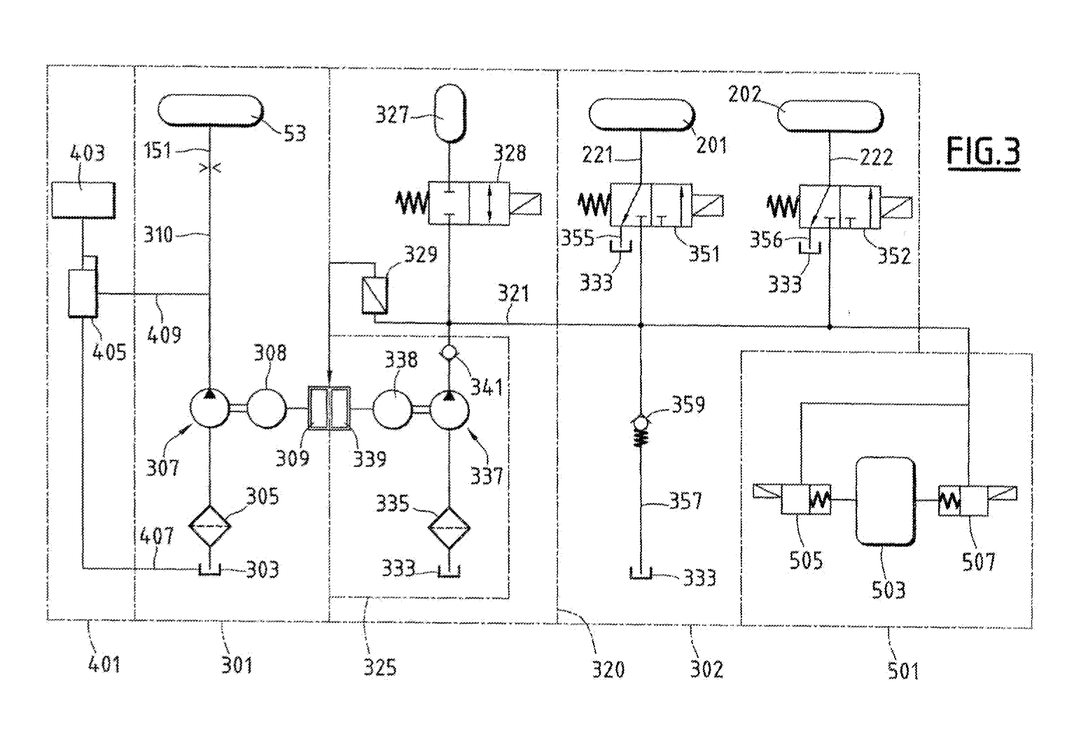

FIG. 3 is a flow chart of a functional assembly according to the invention.

FIGS. 1 and 2 show a transmission element 25 conform to the invention, intended to connect a thermal engine to a gear box. The element 25 of the invention comprises an electrical machine 31, which will be called “electric motor,” a first clutch 33, and a second clutch 35.

The transmission element 25 comprises further coaxial movement input shaft 37 and movement output shaft 39 having an axis X. The axis X is oriented from the input toward the output to facilitate the following description.

The terms “upstream” and “downstream” have a meaning in reference to this orientation.

The input shaft 37 is integral in rotation with the crankshaft of the thermal engine, of which a portion, or “nose,” is shown on FIG. 1 under reference numeral 41.

In the example shown, the crankshaft 41 is equipped with a flywheel 43, and connected to the input shaft 37 via a damping device 45.

The output shaft 39 is linked in rotation to the primary gear box input shaft, of which a portion is shown on FIG. 1 under reference numeral 47.

The transmission element 25 comprises a casing constituted essentially by a first half-shell 51 and a second half-shell 52, assembled by fixation means distributed over the periphery of the casing and symbolized on FIG. 1 by interrupted lines 54. The casing half-shells 51, 52 delimitate internally a housing 53, inside which are arranged the electric motor 31, the clutches 33, 35, and the input 37 and output 39 shafts, in a coaxial manner.

The input shaft 37 and the output shaft 39 are mounted movable in a rotation with respect to the casing 51, 52.

The input shaft 37 is a fluted shaft complementary to a hollow shaft 55 of the damping device 45, and an end portion of the input shaft 37 protrudes axially from the first half-shell 51. The input shaft 37 is mounted movable in rotation on the first half-shell 51 via a rolling bearing 57.

The output shaft 39 is a hollow shaft with internal flutes, having a shape complementary to the end of the gear box input shaft 47. To be engaged with the output shaft 39, the end of the gear box input shaft 47 protrudes inside the housing 53.

The electric motor 31 comprises a stator 61, equipped with a collector, integral with the first casing half-shell 51, and a rotor 63 mounted movable in rotation on the first half-shell 51 via a bearing 65. The rotor 63 is arranged radially inside the stator 61.

The first 33 and second 35 clutches are of the wet type, and the transmission element 25 is equipped with an axial tube 71 for distribution of lubrication and cooling fluid as well as for control. This tube 71 protrudes inside the housing 53 of the second casing half-shell 52.

The transmission element 25 has an intermediate transmission member 73 mounted movable in rotation on the tube 71, radially outside, via two bearings 75, 76.

The intermediate member 73 is formed essentially with a hub 80, and four radial walls 81, 82, 83, 84, shifted axially with respect to each other, and made integral with the hub 80 by welding for walls 81, 82, 84, and by hooping for wall 83.

The intermediate member 73 is linked in rotation with the rotor 63 via complementary axial teeth 87 which are mutually engaged, and formed on a peripheral portion of the rotor 63 and on a peripheral portion of the first radial wall 81, respectively.

The second radial wall 82 is formed with an integral peripheral ring constituted by a first half-ring 91 extending in the downstream axial direction, and a second half-ring 92 extending in the upstream axial direction.

Correspondingly, the input shaft 37 is formed, preferably in one piece, with a radial wall 95 which extends inside the housing 53, and which has at its periphery an axial ring 97. The axial ring 97 extends in a coaxial and radially external manner, with respect to the downstream half-ring 91. The first clutch 33 is arranged between said half-ring 91 and said ring 97.

In the same manner, the output shaft 39 is formed, preferably in one piece, with a radial wall 105 which extends inside the housing 53, and which has at its periphery an axial ring 107. The axial ring 107 extends in a coaxial and radially external manner, with respect to the upstream half-ring 92 of the intermediate member 73. The second clutch 35 is arranged between said half-ring 92 and said axial ring 107.

The transmission element 25 comprises further a first actuating piston 111 and a second actuating piston 112 of the first clutch 33 and of the second clutch 35, respectively, as well as a first spring member 115 and a second spring member 116 acting on the first piston 111 and on the second piston 112, respectively, toward pressing on the respective clutch 33, 35.

Between the piston 112 and the spring member 116 is interposed, supported axially, a spacer having essentially axial fingers 117 distributed on the periphery of a ring. These fingers 117 pass through the wall 82.

The first clutch 33 is essentially constituted by a first series of discs 121 linked in rotation to the first half-ring 91 by flutes, and movable axially on the latter, along these flutes, under the action of piston 111; and of a second series of discs 122 linked in rotation to the axial ring 97 by flutes, and movable axially on the latter, along these flutes also under the effect of piston 111. The first discs 121 and the second discs 122 are interleaved with each other in an alternating manner.

The discs 121, 122 are stopped axially by a stop 123 opposed to the piston 111.

It is observed that the discs 121, 122 can pass from an unclutched position, in which the first discs 121 are not in contact with the second discs 122, and an engaged position of the first discs 121 and second discs 122, in which the first discs 121 and second discs 122 are pressed against each other.

In the unclutched position, the input shaft 37 and the intermediate member 73 are free in rotation with respect to each other.

The first spring member 115, constituted in the example shown by a spring-washer, for example, of the Belleville washer type, is fixed to the first radial wall 81, and acts on the piston 111 in the engaged position.

The second clutch 35 has a constitution and operation analogous to the first: it comprises a first series of discs 131 associated to the second half-ring 92, and a second series of interleaved discs 132, associated to the axial ring 107. The axial movement of the discs 131, 132 is limited by a stop 133.

In the example shown, the spring member 116 is a double spring washer, of the Belleville type, fixed to the second wall 82. The spring member 116 acts on the piston 112 toward the engaged position of the second clutch 35, via fingers 117.

As is visible on FIG. 1, the two clutches 33, 35 are shifted axially and radially according to a tiered or “stepped” arrangement, i.e., the first clutch 33 is disposed radially outside with respect to the second clutch 35. The latter is arranged inside the rotor 63.

The transmission element 25 is further equipped with needle stops, among which a first one 141 is interposed axially between the bearing 65 and the radial wall 95 of the input shaft 37; a second one 142 is interposed axially between the radial wall 95 and the radial wall 105 of the output shaft 39; a third one 143 is interposed between the radial wall 105 and the radial wall 84 of the intermediate member 73; and a fourth one 144 is interposed between the hub 80 and a shoulder of the tube 71.

The fluid distribution tube 71 is adapted to distribute lubrication and cooling fluid inside the transmission element 25, i.e., inside the housing 53. The latter is sealed against this fluid, in particular in the area of the jointing of the two casing half-shells 51, 52, by means of a peripheral seal 150.

In the vicinity of the axis X, the sealing of the transmission element 25 against the lubrication and cooling fluid is obtained, on the one hand, by a first lip seal 181, which is supported on the first half-shell 51 and the outside surface of the hollow shaft 55, and by a second lip seal 182, which is supported on the inside surface of the tube 71 and on the outside surfaces of the primary gear box input shaft 47, and on the other hand, by an O-ring 183 placed between the input shaft 37 and the hollow shaft 55.

This tube 71 has, provided in its wall, a first fluid supply radial channel 151, a first distribution axial channel 153 connected to said supply channel 151, an orifice 155 provided between the distribution channel 153 and the outside of the tube 71, and an orifice 157 provided between the distribution channel 153 and the inside of the tube.

The hub 80 of the intermediate member 73 is equipped with a channel 161 opening onto the orifice 155, and setting in communication the distribution channel 153 and the housing 53.

In operation, the supply channel 151 is connected to a circuit, which will be described below, for the supply of cooling and lubrication fluid. This fluid is diffused inside the housing 53 via the distribution channel 153, the orifice 155, and the channel 161, so as to lubricate and cool the first clutch 33, the second clutch 35, and the electric motor 31.

It will be noted that the lubrication and cooling fluid is diffused radially toward the stator 61, thanks in particular to the passage 163 provided in the area of the teeth 87. The dimensioning of this passage 163 makes it possible to control the fluid flow rate organized between the portion of the housing 53 internal to the rotor 63, and the external portion in which the stator 61 is arranged.

It will also be noted that the relative disposition of the clutches 33, 35, and of the electric motor 31 makes it possible, due to the centrifugation of the lubrication and cooling fluid, to keep the first clutch 33 in a bath of lubrication and cooling fluid, during operation of the transmission element 25, whereas the area of the second clutch 35 is the seat of a mist of this same fluid. The interest of this disposition is to adapt the amount of fluid, present in the area of each clutch, in particular the calorific energy generated by these clutches.

The bath of fluid, in general, oil, in which the clutch 33 is maintained, is leveled thanks to a passage 164 in the area of the radial wall 81.

The first clutch 33 being subjected to heating more importantly than the second clutch 35, it is indeed necessary to organize, in the vicinity of first clutch, a markedly higher flow rate of cooling fluid.

The more important heating of the clutch 33, as compared to the clutch 35, is due to slipping phases, which are more constraining for the first than for the second. Further, maintaining the clutch 35 in a mist of fluid, rather than in a bath, makes it possible to reduce the drag forces of this fluid on the primary gear box shaft.

Further, the cooling and lubrication fluid is distributed toward the rolling bearing 57 and the bearing 65 to cool and lubricate the latter, via, successively: the distribution channel 153; the orifice 157; a radial passage 171 formed in the primary gear box input shaft 47; an axial channel 172 provided in this shaft; a nozzle 175 making it possible to adjust the fluid flow rate; an axial channel 177 formed in the input shaft 37; and, finally, a radial passage 179 opening in the vicinity of the rolling bearing 57.

The fluid distributed along this path flows into the housing 53, through the rolling bearing 57, toward the bearing 65 and the rotor 63, then toward the stator 61. The stator 61 and the rotor 63 are thus cooled and lubricated, not only by fluid which has transited via the orifice 155 and the passages 163, 164, but also by fluid which has transited via the orifice 157 and the path detailed previously. This fluid also makes it possible to lubricate the stops 141, 142, 143.

The dispositions that make it possible to move the pressure pistons or plates 111, 112, and thus to move the clutches 33, 35 from a position to another among their engaged and unclutched positions, will now be described.

The first piston 111 defines, with the third radial wall 83 and the outside surface of the hub 80, a first pressure chamber 201, while the second piston 112 defines, with the fourth radial wall 84 and the outside surface of the hub 80, a second pressure chamber 202.

The first pressure chamber 201 is substantially sealed with respect to a control fluid by means of a lip seal 205 fixed in the periphery of the radial wall 83, and applied on a surface of the piston 111, and of a lip seal 206 fixed on a radially internal edge of the piston 111, and applied on the outside surface of the hub 80.

In an analogous manner, the pressure chamber 202 is substantially sealed by a first seal 215 applied on the radial wall 84 and the piston 112, and by a second lip seal 216 applied on the piston 112 and the outside surface of a part 217 arranged on the hub 80.

Each pressure chamber 201, 202 opens into the central bore of the hub 80 via two channels 221, 222, respectively, for the passage of the control fluid supply, formed in the hub 80.

The fluid distribution tube 71 is itself equipped with two channels 231, 232, connected to a control fluid supply circuit via respective radial supply channels (not shown) analogous to the channel 151, and respective axial distribution channels (not shown) analogous to the channel 153. The channels 231, 232, communicate with the passages 221, 222, respectively.

In the example shown, the control fluid is the same as the lubrication/cooling fluid, the control and lubrication/cooling circuits being partially common.

It is observed that, from an initially closed position of the clutch 33, 35, the passage to the unclutched position is obtained by supplying the respective pressure chamber 201, 202 with pressurized control fluid. The corresponding piston 111, 112 is then moved axially in the downstream direction, according to the orientation of the axis X (toward the left on FIG. 2), while compressing the spring member 115, 116 and releasing the piles of discs 121, 122, 131, 132.

Under the action of the spring 115, 116, the piston 111, 112 goes back to its initial position when the pressure of the control fluid in the respective pressure chamber 201, 202 is brought back to its low initial value. The clutch 33, 35 goes back then to its so-called “naturally closed,” i.e., engaged, position, in the absence of a supply of the pressure chamber 201, 202 with control fluid.

It is observed that the two clutches 33, 35 can be operated independently, and that the description above relative to the operation of the clutches 33, 35 applies to one or the other independently.

Further, the pressure of control fluid which can be delivered to the pressure chambers 201, 202 can vary over a range of values, such that the corresponding clutch 33, 35 can be brought in one among zero (unclutched), total (engaged), or partial (sliding) transmission states.

It must be observed that the second radial wall 82 and the piston 112 define between them a compensation chamber 235, located on the side opposite the second pressure chamber 202 with respect to the piston 112. This compensation chamber 235 is supplied with lubrication and cooling fluid via the channel 161 and an orifice 237 provided in the radial wall 82. Thus, at high engine speed, the additional forces generated on the piston 112 by the centrifugation of the control fluid contained in the second pressure chamber 202 are compensated, and the piston 112 operates so as to allow the passage, between the discs 131, 132, of the torque for which it has been dimensioned. It can also be noted that the dimensioning of the clutch 33, of the piston 111, and of the spring 115, makes it possible to avoid a compensation chamber for the control of this clutch 33.

In reference to FIG. 3, a hydraulic control circuit according to the invention will now be described.

The latter comprises a transmission element such as described above, as well as a hydraulic control circuit 302 of the clutches 33, 35, and a hydraulic cooling and lubrication circuit 301 of the transmission element 25.

The functional assembly comprises further a first hydraulic system 401 of the vehicle, connected to the lubrication circuit 301, and a second hydraulic system 501 of the vehicle, connected to the control circuit 302.

It is observed on FIG. 3, in the first place, that the cooling and lubrication circuit 301 is distinct from the control circuit 302.

The cooling and lubrication circuit 301 comprises:
a tank 303 of cooling and lubrication fluid, such as oil,
a filtration element (or strainer) 305 placed at the output of said tank,
a low pressure pump 307 equipped with a motor 308 and a control unit 309 of said motor, and
a lubrication conduit 310 connecting the pump 307 to the housing 53 of the transmission element 25, via the supply channel 151, and the fluid distribution tube 71. The control circuit 302 comprises a source of pressure 320, equipped with an output conduit 321 constituting an emission conduit of control fluid toward the pressure chambers 201, 202 of the clutches 33, 35.

The source of pressure 320 comprises a pressure generator 325, a pressure accumulator 327, an electrovalve 328 connecting the pressure accumulator 327 to the emission conduit 321, and an emission pressure sensor 329, which measures the control fluid pressure prevailing in the emission conduit 321.

The pressure generator 325 comprises
a control fluid tank 333,
a filtration element (or strainer) 335 placed at the output of the tank,
a high pressure pump 337, equipped with a motor 338 and a control unit 339 of this motor.

In the example shown, the control unit 339 of the motor of the high pressure pump and the control unit 309 of the motor of the low pressure pump are physically united into a same central control member.

The pressure generator 325 comprises further a check valve 341, via which the high pressure pump 337 is connected to the emission conduit 321, so that the control fluid can circulate only from the pump 337 to the emission conduit 321.

The electrovalve 328 is capable of taking two positions:
in the first position, a rest position, corresponding to a neutral operation mode of the accumulator 327, the latter is isolated from the emission conduit 321 (position shown on FIG. 3), and
in the second position, an active position, the accumulator 327 communicates with the emission conduit 321, the control fluid being able to flow in one direction or the other. The accumulator operates then according to a fluid receptor or emitter mode.

The control unit 339 drives the motor 338 so as to deliver control fluid into the emission conduit 321, with a view at recharging the pressure accumulator 327, when the electrovalve 328 is in its second position.

The pressure sensor 329 is connected to the control unit 339, as well as to the control unit 309, making it possible for the control units to drive the respective motors 338, 308 as a function of the control fluid pressure prevailing in the emission conduit 321.

The emission conduit 321 is connected to each of the channels 221, 222 for passage of control fluid, opening into the respective pressure chambers 201, 202, via respective proportional electrovalves 351, 352 having two extreme positions.

Each of these electrovalves 351, 352 of the control circuit 302 can take selectively a position among an extreme rest position (shown on FIG. 3), an extreme active position, and intermediary active positions.

In the rest position, the pressure chamber 201, 202 is set in communication with a discharge circuit 355, 356, which may open, for example, into the tank 333, and isolated from the emission conduit 321.

In the active positions, the pressure chamber 201, 202 is set in communication with the emission conduit 321 so as to be able to be supplied in control fluid, while the discharge circuit 355, 356 is closed in the area of the electrovalve 351, 352.

The control circuit 302 comprises further another discharge circuit 357 connected to the emission conduit 321 via a security valve 359, intended so as to open and set the emission conduit 321 in communication with the discharge circuit 357, when the pressure in the emission conduit is higher than a predetermined threshold value. The discharge circuit 357 can be connected to the tank 333 of control fluid, so as to recycle the excess fluid in the emission conduit 321.

The operation of the control circuit 302 will now be described.

The clutches 33, 35 are assumed to be, in the initial state, in their engaged (or closed) positions, the pressure prevailing in the pressure chambers 201, 202 being at a low value P₀.

The pressure accumulator 327 must, at each instant, be charged so as to be able to supply with a very short response time, into the pressure chambers 201, 202, a fluid pressure called “high pressure,” P₁, sufficient to move the pistons 111, 112 until the clutches 33, 35 are brought into their unclutched (or closed) configuration. If this is not the case, the control unit 339 actuates the pump motor 338, and the electrovalve 328 is moved into its active position, so that the pressure accumulator 327 is recharged.

When one of the clutches 33, 35 must be brought into a sliding position, or into the completely unclutched position, the corresponding electrovalve 351, 352 is moved into an adapted active position. Simultaneously, the electrovalve 328 is also moved into an active position. The check valve 341 preventing the fluid contained in the emission conduit 321 from returning toward the generator 325, the fluid coming from the accumulator 327 is introduced into the pressure chamber 201, 202, in which the pressure reaches quasi-instantaneously the target value. At this target value is associated a position of the respective proportional valve 351 or 352.

In particular, the pressure in one and/or the other of the two chambers can reach quasi-instantaneously the high value P₁, which constitutes the declutch control value.

Of course, the two clutches 33, 35 can be actuated in an independent manner.

It is observed also that, if both clutches 33, 35 must be brought into unclutched positions at the same time, both electrovalves 351, 352 are operated as indicated above.

In the example shown, the first hydraulic system 401 is a hydraulic power steering system equipped with an actuator 403, constituting a fluid receptor member, a valve 405 for supply and discharge of the actuator 403, as well as a tank of fluid, and a pump for supply of the actuator with pressurized fluid from the tank.

As shown on FIG. 3, the tank 303 and the pump 307 of the lubrication circuit 301 are constituted by the tank and by the pump of the first hydraulic system 401 provided on the vehicle, respectively.

The hydraulic power steering valve 405 is connected, on the one hand, to the tank 403 by a discharge channel 407, and on the other hand, to the lubrication conduit 310, downstream of the pump 307, by a charge channel 409.

Thus, the fluid used in the lubrication circuit 301 is the same as the fluid used in the first hydraulic system 401, and similarly, the hydraulic circuit components constituted by the tank 303, the strainer 305, and the pump 307 are common to the lubrication circuit 301 and to the first hydraulic system 401.

According to variant embodiments of the invention, the first hydraulic system can be constituted by a cooling and lubrication system of another transmission element, the latter constituting the fluid receptor member; or by a hydraulic braking system, the receptor member being then constituted by a brake; or by a hydraulic system, the receptor member being then constituted by a hydraulic cylinder.

The second hydraulic system 501, connected to the control circuit 302, is, in the example shown, constituted by a driven manual gear box system.

This system 501 comprises a driven manual gear box 503, a gear box actuator 505, and a gear shifting actuator 507. The actuators 505, 507 constitute together the fluid receptor member of the second hydraulic system 501.

The second hydraulic system 501 comprises further a tank of fluid, and a pump making it possible to supply the receptor member 505, 507 with pressurized fluid.

Each of the actuators 505, 507 is connected to the emission conduit 321 of the control circuit 302, so that the tank 333 and the high pressure pump 337 of the control circuit 302 are constituted by the tank and by the pump of the second hydraulic system 501 provided on the vehicle, respectively.

In a manner analogous to what has been described for the lubrication circuit 301 and the first hydraulic system 401, the control circuit 302 and the second hydraulic system 501 use the same control fluid and have common parts, which are essentially the tank 333, the strainer 335, and the pump 337.

It is observed that the pooling of some parts of hydraulic circuits provided in a standard manner on a vehicle, with hydraulic circuits associated to a transmission element of a hybrid traction chain, makes it possible to simplify considerably the architecture of these hydraulic circuits, as well as their size and their cost. The invention facilitates also the integration, into a standard traction chain, of a transmission element of the hybrid type.

1. Functional motor vehicle assembly comprising:
at least one hydraulic system equipped with a tank of fluid, a receptor member, and a pump connected, on the one hand, to said tank, and on the other hand, to said receptor member, adapted to supply the receptor member with fluid from the tank, and
a transmission element comprising a movement input shaft intended to be connected to a thermal engine, a movement output shaft intended to be connected to a gear box, an electrical machine comprising a stator and a rotor, a first intermediate member between the input shaft and the rotor, and a second intermediate member between the rotor and the output shaft, said clutches being of the wet type, said transmission element further comprising a circuit of lubrication and/or cooling fluid, and control means of said clutches, which comprise a circuit of control fluid, the control circuit comprising a pressure chamber for each clutch, such that the control fluid pressure prevailing in a pressure chamber determines the state of the respective clutch,
wherein one of said circuits is connected to said hydraulic system, so that the fluid of said circuit is identical to the first fluid of said hydraulic circuit, and said circuit is supplied with fluid from said tank by said pump.

2. Functional motor vehicle assembly according to claim 1, wherein said hydraulic system is a lubrication and/or cooling system of a second transmission element which constitutes the receptor member, or a hydraulic power steering system in which the receptor member is a power steering actuator, or a hydraulic braking system in which the receptor member is a brake, or a hydraulic suspension system in which the receptor member is a hydraulic cylinder, and in that the circuit connected to said hydraulic system is the circuit of lubrication and/or cooling fluid.

3. Functional motor vehicle assembly according to claim 1, wherein said hydraulic system is a gear box system, in particular a driven manual gear box, the receptor member comprising a selection actuator and a gear shifting actuator, and in that the circuit connected to said hydraulic system is the circuit of control fluid.

4. Transmission element according to claim 2,
wherein said hydraulic system is a gear box system, in particular a driven manual gear box, the receptor member comprising a selection actuator and a gear shifting actuator, and in that the circuit connected to said hydraulic system is the circuit of control fluid, and
wherein the transmission element comprises two such hydraulic systems, connected to the and to the circuit of lubrication and/or cooling fluid and to the circuit of control fluid, respectively.

5. Transmission element according to claim 1, wherein said control means comprise return means of the two clutches into closed position.

6. Transmission element according to claim 1, wherein the control circuit is essentially distinct from the lubrication and/or cooling circuit.

7. Transmission element according to claim 1, wherein the control fluid is of a different nature from the lubrication and/or cooling fluid.

8. Motor vehicle it which comprises a functional assembly according to claim 1.
